(19) United States
(12) Patent Application Publication
(10) Pub. No.: US 2018/0127153 A1
(43) Pub. Date: May 10, 2018

(54) Gentie George Wesley Collection - Special Designed Lawn Cair Magazine and Newspaper Holder

(71) Applicant: Cleo Miller-Chaneyfield, Hiram, GA (US)

(72) Inventor: Cleo Miller-Chaneyfield, Hiram, GA (US)

(21) Appl. No.: 15/330,866

(22) Filed: Nov. 9, 2016

(51) Int. Cl. B65D 25/22; B42D 17/00; A45C 11/00

(52) U.S. Cl. CPC B65D 25/22; A45C 2011/003; A45C 11/00; B42D 17/00

(57) ABSTRACT

The Special Designed Lawn Chair Magazine and Newspaper Holder is a well needed lawn and garden accessories. The holder is designed to fit comfortably on the arm rest of a lawn chair. It is designed to remain stable on the chair while holding a person item private. It also provides comfort to a person while sitting in a lawn chair or where placed.

The holder is designed with special dimensions for extreme comfort on the arm rest of a chair. It is designed to make items easy to retrieve and accessible The holder is designed to remain stable on the lawn chair as placed while sitting or when leaving the chair. Its gives the person the privacy, comfort and convenience that is highly desired while sitting outside in a lawn chair. When a person leave the chair, it provides them with the same comfort and privacy as they had before they left the chair.

### CROSS-REFERENCE TO RELATED APPLICATIONS

N/A

### STATEMENT REGARDING FEDERALLY SPONSORED RESEARCH OR DEVELOPMENT (IF APPLICABLE)

N/A

### REFERENCE TO SEQUENCE LISTING, A TABLE OR A COMPUTER PROGRAM LISTING COMPACT DISC APPENDIX (IF APPLICABLE)

N/A

### BACKGROUND OF INVENTION

This Special Designed Lawn Chair Magazine and Newspaper Holder would fall under the Lawn and Garden Furniture Accessories. I was studying for my Project Management Professional (PMP) Certification Exam and I was putting my books/pencils/cellphone/calculator . . . etc. on the floor of the deck. It was very annoying and time consuming to reach on the floor time after time to retrieve the items that I needed. I then decided that I could resolve this problem by making something to make these items easy to retrieve and more accessible to me. I did just that and now retrieving those items are easy to retrieve and more accessible, it saves me time and it also provides me privacy of the items inside the holder.

### BRIEF SUMMARY OF INVENTION

This Special Designed Lawn Chair Magazine and Newspaper Holder is specially designed for lawn chairs or however a user decides to use. The benefit of this special designed Magazine and Newspaper holder is to make items easy to retrieve and accessible while providing privacy of the items that are kept inside the holder. The holder is designed to remain stable on the lawn chair as placed while sitting or when leaving the chair. Its gives the person the privacy, comfort and convenience that is highly desired while sitting outside in a lawn chair. The Special Designed Lawn Chair Magazine and Newspaper Holder is portable and user friendly.

### BRIEF DESCRIPTION OF THE VIEWS OF THE DRAWINGS

The Special Design Lawn Chair Magazine and Newspaper Holder may be used to hold Magazines, Newspaper, Cellphone, IPAD or what the user decides.

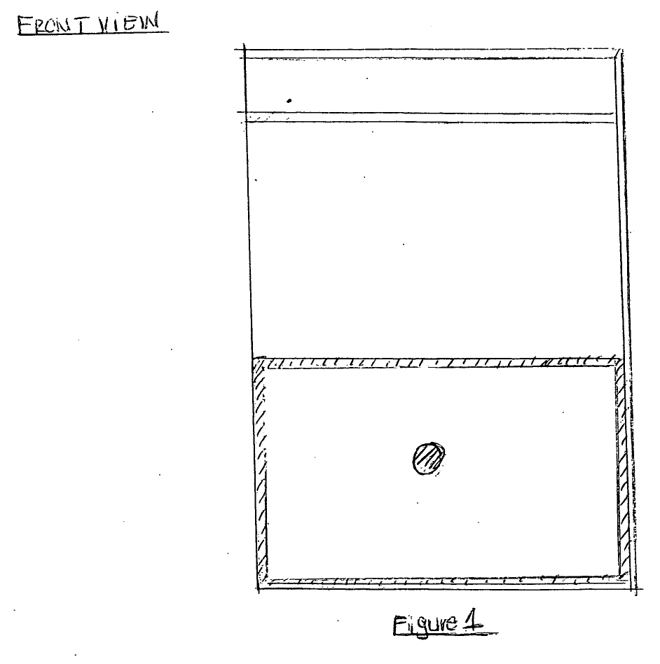

1. Attached—FIG. 1 of 3 is the front view of the Special Design Lawn Chair Holder with a slight elevation.

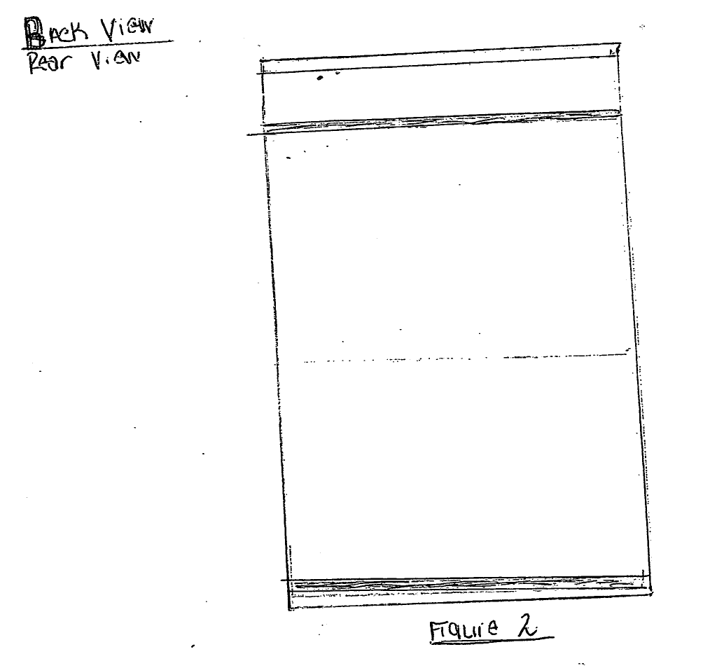

2. Attached—FIG. 2 of 3 is the back/rear view of the Special Design Lawn Chair Holder with a slight elevation.

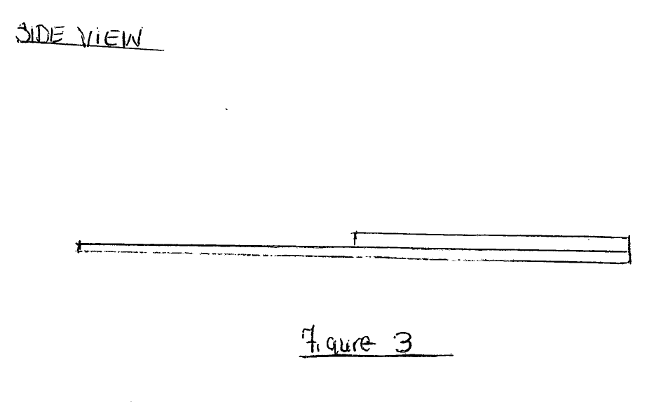

3. Attached—FIG. 3 of 3 is the side view of the Special Design Lawn Chair Holder with a slight elevation.

### DETAIL DESCRIPTION OF THE INVENTION

This Special Designed Lawn Chair Magazine and Newspaper Holder is specially designed for lawn chairs or however a user decides to use. The benefit of this special designed Magazine and Newspaper holder is to make items easy to retrieve and accessible while providing privacy of the items that are kept inside the holder. The holder is designed to remain stable on the lawn chair as placed while sitting or when leaving the chair. Its gives the person the privacy, comfort and convenience that is highly desired while sitting outside in a lawn chair.

This Special Designed Lawn Chair Magazine and Newspaper Holder is designed to fit comfortably on the arm rest of a lawn chair. It is designed to remain stable on the chair while holding a person personal item. The holder is designed with special dimensions for extreme comfort. The holder is also portable and user friendly.

The total length of the base of the Special Designed Lawn Chair Magazine and Newspaper Holder is 24 inches in length and 13 inches in width with the base color of the holder being cream, with the fabric being of leather. The pocket base is 10 inches in length and 13 inches in width with color being black, with the fabric being of leather.

The pocket is trim with 1 inch in diameter fabric and is attached around the perimeter of the pocket and holder external perimeter. There is one button positioned centered of the pocket and covered with the same fabric as the trim.

The Process to Make the Gentie George Wesley Special Design Magazine and Newspaper Holder is as Following:
1. Cut two pieces of fabric 13×25 inches, turn fabric outside in and sew the 2 sides and the bottom of the fabric about ½ in from the edges leaving one end open. Lightly press the stitches and turn the fabric inside out with the leather being on the outside.
2. Cut one (1) 21 inches of 1¼×⅛ in×36 inches width piece of Flat Bar Zinc by Everbilt to be used as the weight with a total length of 12 inches and insert the weight, which will fall into position lying flat to the bottom of the holder. Stitch the holder about ½ in from the weight to hold the weight in place. This is now known as the top of the base holder.
3. Cut 1 piece of trim with size being 14 inches in length. Then press the ends of the trim under about 1/10 inches in diameter, then attach the trim to the base holder on the stitch where it has been attached to the base by stitching the trim fabric about 1/10 inch around both sides of the trim wrapping the trim to the back of the holder.
4. Cut 1 piece of 10×13 inches of the black leather fabric, this is now known as the pocket of the Special Designed Lawn Chair Magazine and Newspaper Holder. Cut 2 pieces of trim 11 inches in length and Cut 2 pieces of trim 14 inches in length. Then press the ends of the trim under 1/10 inches in diameter.
5. Now attach the 11 inches trim to the pocket by stitching both sides of trim about 1/10 inch to the 10 inch sides of the pocket.
6. Now attach 1 piece of the 13 inches trim to one side of the pocket by stitching both sides of trim about 1/10 inch to the 13 inch sides of the pocket, this is now known as the top of the pocket.
7. Place the pocket faced up with the side of the missing trim, which is now known as the bottom of pocket. Line the corners of the bottom of the pocket to the corners of the base of the holder.
8. The pocket is now attached to the base by stitching 1/10 inch to each side (left and right) of the pocket, and attaching the 14 inches trim to the holder base at the bottom and stitch 1/10 inch on both sides of the trim wrapping the 14 inch piece to the back of the pocket.
9. Cut two (2) pieces of bias black 1 inch sewing tape 14 inch in length. Then press the ends of the tape under about 1/10 inches in diameter, then attach by stitching the tape to the back side of the holder base at bottom and at the top below the weight which is about 2 inch from the top, covering the stitch of the trim from the front of the holder. Stitch about 1/10 inch around both sides of the tape. The tape is sown over the tread to embrace style.
10. The button is made with the same fabric as the trim using the Dritz Cover Button Application and then attached to the center of the pocket by hand.
11. The Gentie George Wesley Magazine and Newspaper holder is complete and ready for use.

### DRAWINGS

The Special Design Lawn Chair Magazine and Newspaper Holder may be used to hold Magazines, Newspaper, Cellphone, IPAD or what the user decides.

1. Attached—FIG. 1 of 3 is the front view of the Special Design Lawn Chair Holder with a slight elevation.

2. Attached—FIG. 2 of 3 is the rear view of the Special Design Lawn Chair Holder with a slight elevation.

3. Attached—FIG. 3 of 3 is the side view of the Special Design Lawn Chair Holder with a slight elevation.

1. Comfort—This Special Designed Lawn Chair Magazine and Newspaper Holder is designed with special dimensions for extreme comfort on the arm rest of a lawn chair. If a person falls to sleep in the chair they will enjoy the benefit of the Magazine and Newspaper holder.

2. Privacy—This Special Designed Lawn Chair Magazine and Newspaper Holder provides privacy of items you are reading or studying if you are sitting in the chair or if you leave the chair.

3. Portable—This Special Designed Lawn Chair Magazine and Newspaper Holder is made of leather fabric so it can be transported as easy as clothing.

4. Stability—This Special Designed Lawn Chair Magazine and Newspaper Holder remains stable on the lawn chair arm rest at what position It is placed on the chair.

5. User Friendly—This Special Designed Lawn Chair Magazine and Newspaper Holder is very easy to setup on the lawn chair.

6. Style—This Special Designed Lawn Chair Magazine and Newspaper Holder style is designed of high quality and status which is embraced with One (1) button matching the outlined trim of the holder. The fabric consists of leather a highly durable fabric in two different tones or colors.

7. Use—Magazine, Newspaper, Books, Cellphones, IPAD . . . etc
